(19) United States
(12) Patent Application Publication
(10) Pub. No.: US 2002/0180264 A1
(43) Pub. Date: Dec. 5, 2002

(54) Pneumatic brake pipe system with separate service and emergency portions

(76) Inventor: Robert Moffitt, Palm Bay, FL (US)

Correspondence Address: John L. DeAngelis, Jr., Esquire, Holland & Knight LLP, Suite 201, 1499 S. Harbor City Blvd., Melbourne, FL, 32901, US

(21) Appl. No.: 10/147,109

(22) Filed: May 16, 2002

Related U.S. Application Data
(60) Provisional application No. 60/291,341, filed on May 16, 2001.

(51) Int. Cl. B60T 8/34

(52) U.S. Cl. 303/128; 303/122

(57) ABSTRACT

A pneumatic valve module for a train railcar. The pneumatic valve module operates in an electronically-controlled mode or in a conventional pneumatic controlled mode. In either mode, the valve module is responsive to a pneumatic emergency brake signal for making an emergency brake application. Also, in the electronically-controlled mode an electronic signal (supplied over a conductor or a wireless communications link) commands a controller on each railcar to apply or release the brakes. In the pneumatic-controlled mode, various reservoir pressures are measured to apply and release the brakes in response to the measured pressures.

### FIELD OF THE INVENTION

This invention relates generally to pneumatic braking systems and more specifically to a pneumatic braking system in which the emergency braking components are segregated from the service braking components.

### BACKGROUND OF THE INVENTION

One of the most critical aspects of the operation of railroad vehicles, particularly freight trains, is the predictable and successful operation of the air brake system. For many years, railroad trains have operated with pneumatic brakes for braking the locomotive and the individual railcars. In a typical system, the locomotive supplies pressurized air to the railcars through a brake pipe extending the length of the train. The brake pipe of each railcar is serially connected to the brake pipe of the adjacent railcars via a flexible hose connector, sometimes referred to as a glad hand.

At each railcar, a control valve (typically a plurality of valves and interconnecting piping) responds to changes in the brake pipe pressure by applying the brakes (in response to a decrease in brake pipe pressure) or by releasing the brakes (in response to an increase in the brake pipe pressure). Application of the brakes is accomplished by using compressed air from a railcar reservoir to drive the brake shoes against the railcar wheels. The railcar reservoir is charged from the brake pipe during non-braking intervals. The brake pipe therefore serves to both supply the pressurized air to each railcar for driving the brake cylinders, thereby applying the brake shoes against the railcar wheels, and also as the medium for communicating brake application and release instructions to each railcar.

In a typical prior art pneumatic brake system, the locomotive operator commands the railcars to apply their air brakes by creating a pressure drop of approximately seven to twenty-four psi in the brake pipe, with a nominal steady state pressure of about 90 psi. Each railcar senses the drop in air pressure as it propagates along the brake pipe and supplies pressurized air from the local railcar reservoir to the wheel brake cylinders. The brake pressure applied to the railcar wheels is proportional to the change in the brake pipe pressure in the brake pipe. To release the brakes, the operator increases the pressure in the brake pipe, which is interpreted by the individual railcars as a command to release the brakes.

The railcar brakes are applied either as a service brake application or as an emergency brake application. A service brake application involves the application of reduced braking forces to the railcar to slow the train or bring it to a stop at a predetermined location. During these brake applications the brake pipe pressure is slowly reduced and the brakes applied in response thereto. An emergency brake application commands an immediate evacuation of the brake pipe and immediate application of the railcar brakes. Unfortunately, because the brake pipe runs for several thousand yards the length of the train, the evacuation does not occur instantaneously along the entire length of the brake pipe. After an emergency brake application or after two or three service brake applications, the brake system must be recharged back to its normal operational pressure before additional brake applications can be made. The railcar brakes are released by initiating the brake pipe recharging process, but there is no provision for gradual release of the brakes. Once the brake pipe begins to recharge, the railcar brakes are released and the brakes can be applied only by lowering the brake pipe pressure.

The foregoing described pneumatic braking system has been used for many years and has the advantage of being entirely pneumatic. Such systems however are known to have certain disadvantages. For example, because the brake command signal (either an increase or decrease in air pressure) is a pneumatic signal, it must be propagated along the brake pipe to each railcar. Accordingly, on long trains it can take many seconds for the brake application or release signal to propagate to the end of the train. For example, for the cars at the end of the train, up to 60 seconds can elapse between a full service brake command and the resulting full service brake application. This interval includes the propagation time of the brake application command down the brake pipe and the time required for the full service brake pressure application to the brake shoes. Because the applied braking force is a function of the pressure change detected at each railcar, the precision to which the brake application can be controlled is degraded both by the propagation characteristics of the brake pipe and leakage in the closed pneumatic brake pipe system.

As described above, in a typical prior art pneumatic braking system, there is no provision for partially releasing the brakes. Once the brake release signal is received via the brake pipe, each railcar fully releases its brakes. In some situations, it would be desirable for the train operator to affect only a partial release, such as when excessive braking had been applied, but it is desired to reduce the level of braking without fully releasing the brakes. The ability to partially release the brakes would provide the train operator with improved and more precise control over train operation. Also, most prior art railway braking systems do not provide braking pressure variability among the railcars. Generally, all railcars apply the same braking force based on the sensed brake pipe pressure. But, some railcars will decelerate faster than others, e.g., empty cars decelerate faster than loaded railcars. The differential railcar deceleration rates generate considerable forces (called “slack action”) between the railcars and imposes extraordinary stresses on the car draft gear and coupler. The intra-train forces generated by these variable effects require that train operators brake the train judiciously, at a deceleration rate less than what might otherwise be desirable, solely to avoid these forces and the possibility of resulting uncouplings, broken couplers and derailments.

Most railcars include a retainer valve for allowing a partial brake application condition. The valve, when manually activated at a railcar, retains some brake pressure in the brake cylinder even though the main brake valve at the railcar is in a released state, i.e., not commanding a brake application. For example, the retaining valve can be manually set at each railcar before the train reaches a long downhill stretch of track. Retaining air in each brake cylinder sets the railcar brakes so that a constant, but slight, braking force is applied to the brake shoes at each railcar. Thus a minimum braking force is applied during the downhill grade, with the locomotive operator supplementing this braking force as required by discharging air from the brake pipe. As is known, every braking action consumes brake pipe air and after two or three service brake applications the brake pipe may contain insufficient air for subsequent brake applications, until the brake system has been recharged, which can take 5 to 20 minutes in an average length train, depending on leakage from the brake system. The capability to retain some brake pressure, by setting the retaining valves, thus conserves brake pipe air pressure.

During the last several years, electronic-based improvements have been introduced to railway power and braking systems. For example, a system is available to provide communications between multiple locomotives located remote from each other in the train consist, so that a single train operator controls the throttle and locomotive brakes of the head-end and the remote locomotives. The system utilizes a radio frequency (RF) link between the lead locomotive (also referred to as the head end unit) and the remote locomotives to provide throttle and brake control. This system provides more uniform pulling of the railcars and improved locomotive braking performance, because each locomotive generates a pneumatic brake instruction in response to the received RF communication signal (which travels at the speed of light) from the lead locomotive, rather than from the slower brake signal conveyed along the pneumatic brake pipe. Since the brake instructions are generated nearly simultaneously at each locomotive on the train, the railcars receive the brake instruction earlier, as compared to a completely pneumatic system, relying solely on the brake pipe for propagation of the braking signal.

In recent years, the American Association of Railroads (AAR) and certain individual railroads have investigated and begun to use electronically controlled pneumatic (ECP) brake systems. Such systems can provide brake commands via the propagation of an electrical signal over a wire extending the length of the train or via a radio frequency system operative between RF transceivers on the locomotive and on each railcar. The primary benefit of these ECP brake systems is the ability to activate the brakes on each car of the train using a signal that propagates at the speed of light. Thus the ECP brake systems allow for the nearly instantaneous activation of all railcar brakes along the entire train. Typically, the ECP system allows the application of all railcar brakes within about one second, a considerable improvement over the pneumatic systems. As a result, the train can be stopped in about half the distance as compared to the pneumatic systems.

Since the ECP system does not use the brake pipe as a brake signaling medium, brake pipe air is not expended to signal a brake application. Thus the brake pipe requires less frequent recharging. Prior art pneumatic systems can take up to 20 minutes to recharge the train, resulting in costly train delays. When the brakes are applied in an ECP system, the brake pipe recharging process begins immediately, compared to the pneumatic system that must await the release of the brake application before the brake pipe can be recharged. In summary, the ECP system uses the brake pipe solely to supply braking air to the railcars; the brake pipe is not used to signal brake commands.

ECP systems provide better train control because they also provide for partial brake releases at the rail cars. Conventional pneumatic brake systems permit only a full brake release in response to a return to normal brake pipe pressure.

Although wire-based ECP systems provide the benefit of braking signal propagation at the speed of light, the wires that carry the braking signals from car to car are subject to harsh environments and are therefore susceptible to damage. Each railcar glad hand includes an electrical connector for mating with the connector of the next railcar in the train consist to provide a continuous electrical path along the train. If a break or discontinuity develops in the wire, an emergency brake application is automatically initiated and train movement is halted until the break is found and repaired.

In lieu of a wire-based communication system, certain ECP braking systems send brake application and release commands via a radio frequency link to each railcar, where each railcar includes a transceiver for receiving the RF signal, and therefore operates as a node communications network. In one embodiment, synchronous communications in the form of a multi-hop network is employed to send signals outbound and inbound on the train consist. This network provides commands and receives status information from all the nodes (i.e., locomotives and railcars) in the network. The hopping methodology transmits the command repeatedly to the nearby neighbor railcars as it leapfrogs toward its destination, that is, the end of the train or the front of the train.

Due primarily to the long history of using the brake pipe pressure to signal brake applications and releases, most railway standards continue to require a pneumatic-based emergency brake application. Thus, in the event the ECP system fails, whether the system uses an RF or cable communications media, the train operator retains the ability to stop the train by actuating a pneumatic emergency in the brake pipe. The prior art ECP systems do not include this option. These ECP systems respond to an emergency only when the control electronics are operational, and even then venting of the brake pipe is not always sufficient to properly propagate the emergency brake application down the entire train.

Prior art ECP systems require a constant power source at the railcar to power certain valves and retain certain valves in a given position by the application of an electrical signal to the valve solenoid. Typically this power source is an axle generator that stores power in a battery. The axle generator has a high failure rate due to the harsh vibration environment of the train axle, and the battery has a limited life requiring periodic replacement. Additionally, if the train sits for a long period without moving, the batteries can discharge to the point where they cannot supply sufficient current until recharged.

### BRIEF SUMMARY OF THE INVENTION

The present invention offers a novel and non-obvious railroad brake system employing a pneumatic valve module (PVM) in conjunction with an electronic controller that effectively integrates a pneumatic-based system providing emergency brake applications, with an ECP-based system providing the full range of braking commands. The PVM serves the function of a universal railcar brake valve that is operative in a conventional pneumatic control (CPC) mode or in an ECP mode. In the CPC mode, the ECP-based system emulates the function of a standard pneumatic brake system, sensing brake pipe pressure reductions and increases, making appropriate brake applications in response thereto, and assisting in propagating the brake pipe signals down the train. In the ECP mode, the ECP system receives electronic commands from the lead locomotive and executes the commanded brake applications and releases. Pneumatic emergency capability is provided at all times, regardless of the mode of operation.

Thus during the expected transition period during which railroad operators will switch from a pneumatic braking system to the EPC-based braking systems, the PVM can be installed on each railcar and commanded to operate in either mode as required. As the railroads fully deploy ECP systems, the PVM is switched to ECP operation, but advantageously continues to support a purely pneumatic emergency response.

The purely pneumatic emergency braking capability of the PVM as constructed according to the teachings of the present invention, allows an emergency brake application in the event the electronic controller or service-braking application portions of the ECP system are inoperative, thus obviating this potential failure mode. Also the PVM avoids the need for external electrical or pneumatic lines between the service portion (on the service side of the brake pipe bracket) and the emergency portion (on the emergency side of the brake pipe bracket) to apply, sense, or release pneumatic emergency applications. Instead, necessary pneumatic features are contained in each side of the ECP system to seamlessly integrate purely pneumatic emergency functions without these external lines that could be prone to damage or vandalism.

Advantageously, valve configurations are employed to allow certain valves to latch in the desired position using an air supply to limit the power requirements at the railcar.

In one embodiment of the PVM, power is supplied by a pneumatic power unit (PPU) comprising an air powered generator that derives air from the auxiliary reservoir, which in turn derives air from the brake pipe. The PVM is specifically designed to control the flow of air to the emergency and auxiliary reservoirs, and to provide airflow to the pneumatic power unit in such a manner that the associated affects of air diversion from the brake pipe are virtually transparent. The pneumatic power unit contains an air-powered generator that converts air pressure into electrical energy to power the ECP system controller and related electronics components.

In one embodiment of the PVM, power is provided by power system of the railcar such that the PPU is not needed. In this case, the airflow port to the PPU is simply blocked off.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 is a block diagram of a railway braking system including a pneumatic valve module constructed according to the teachings of the present invention;

FIG. 2 is a block diagram of the pneumatic valve module of FIG. 1; and

FIG. 3 is a block diagram of the pneumatic valve module, including the principle components with which it operates.

### DETAILED DESCRIPTION OF THE INVENTION

Before describing in detail the particular braking system in accordance with the present invention, it should be observed that the present invention resides primarily in a novel combination of hardware elements related to a railway braking systems. Accordingly, the hardware elements have been represented by conventional elements in the drawings, showing only those specific details that are pertinent to the present invention, so as not to obscure the disclosure with structural details that will be readily apparent to those skilled in the art having the benefit of the description herein.

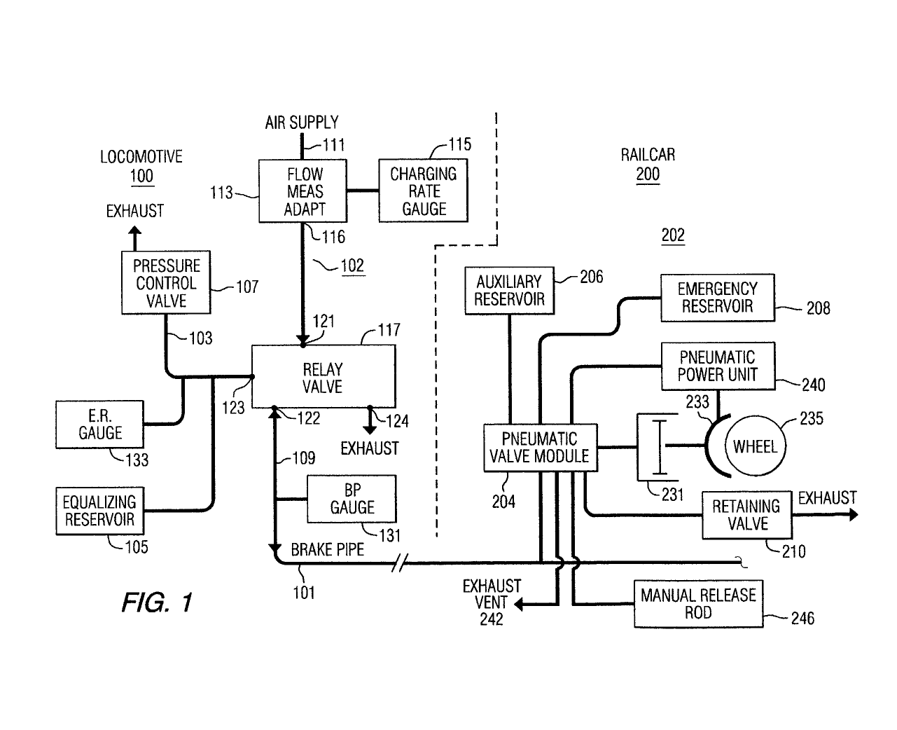

FIG. 1 illustrates the elements of a brake system employed by a railroad train, including a railcar brake system constructed according to the teachings of the present invention. A train brake system 202 comprises a locomotive brake system located on a locomotive 100 and a car brake system located on one or more railcars, illustrated by a car 200. The application and release of braking action is controlled by an operator within the locomotive 100. The locomotive 100 contains an air brake control system 102, including a controllably pressurized brake pipe 101 extending the length of the train, through which pressurized air and brake instructions are supplied to each of the cars 200. The brake control system 102 also includes an air supply input 111 for supplying, fluid (air) under pressure to charge the brake pipe 101. Ultimately, as will be explained further below, the air brake control system 102 controls the operation of the pneumatic-operated brake shoes 233 at each of the wheels 235 of the railcar 200.

Outside air is supplied via an air supply link 111 to an input port 121 of a relay valve 117. A bi-directional port 122 of the relay valve 121 is coupled to the brake pipe 101 via a link 109. The relay valve 117 further includes a port 123 coupled through an air pressure control link 103 to an equalizing reservoir 105. The pressure control link 103 is also connected to a pressure control valve 107 through which the equalizing reservoir 105 is charged and discharged during a brake operation. A exhaust port 124 of the relay valve 117 is controllably vented to the atmosphere. Coupled to the brake pipe 101 are various pressure measuring and display devices not germane to the present invention, and therefore not shown in FIG. 1.

The components of the railcar air brake control system 202 include a pneumatic valve module 204 constructed according to the teachings of the present invention, and responsive to an auxiliary reservoir 206 and an emergency reservoir 208. The pneumatic valve module 204 is also responsive to the brake pipe 101 and a retaining valve 210, which is exhausted to the atmosphere. The pneumatic valve module 204 controls airflow to an air brake cylinder 231 for controlling the movement of the brake shoe 233 against the wheels 235 of the railcar 200. The retaining valve 202 is a manually operated valve that allows the brake cylinder 231 to retain a certain volume of air notwithstanding the brake pipe condition, whether the brake pipe 101 is signaling a full release of the brakes. The pneumatic valve module 204 is also vented directly to the atmosphere via an exhaust vent 242.

The brake system is initially pressurized by operation of the pressure control valve 107, which controls the air supply to the control link 103 so as to fully charge the equalizing reservoir 105. The relay valve 117 is then operative to couple the port 121 with the port 122 so that air is supplied to the brake pipe 101 for charging the brake pipe fluid path to the predetermined charging pressure. This pressure (typically 90 psi) is established by the pressure of the equalizing reservoir 105 in the locomotive 100. Specifically, when the pressure at the port 122 matches the pressure at the port 123 the brake pipe 101 is fully charged and the relay valve 117 is closed.

Through the operation of the pneumatic valve module 204 in each railcar 200, the auxiliary reservoir 206 and the emergency reservoir 208 are fully charged via the brake pipe 101 for use in applying the brakes 233, as will be described in detail below.

When the locomotive operator desires to apply brakes to the wheels 235 of the railcars 200, he operates the pressure control valve 107, typically via a hand-operated control valve lever, causing a partial venting of the air pressure control link 103 and thereby a reduction in the pressure within the equalizing reservoir 105. This reduced pressure in the equalizing reservoir 105 is sensed by the relay valve 117 at the port 123. In turn, this causes the bi-directional port 122 to be coupled to the exhaust port 124, exhausting the brake pipe 101 to the atmosphere until the pressure within the brake pipe 101 equals the pressure of the equalizing reservoir 105.

As the pressure in the brake pipe 101 drops, the pneumatic valve module 204 in each of the railcars 200 senses the pressure reduction and in response thereto applies the brakes 233. This process by which the brakes are applied is described in detail below. Further pressure reductions in the equalizing reservoir 105, under control of the operator, produce corresponding pressure reductions in the brake pipe 101, and thereby the application of additional braking effort by the brake shoes 233 in each of the cars 200. The intended operation of the brake system in the cars 200, and specifically the braking effort applied at each of the cars 200, is proportional to the pressure reduction in the equalizing reservoir 105. For example, if the nominal brake pipe pressure is 90 psi, an operator induced reduction to about 64 psi initiates a full service brake applications. A full service brake application is one that applies considerable braking forces to the train, but not such large forces that control over the railcars can be lost. Comparatively, an emergency brake application is initiated by rapidly evacuating the brake pipe, resulting in the rapid application of maximum braking force at all the railcars. This typically results in a violent reaction at the railcars and may cause loss of train control.

To release the train car brakes, the operator operates the pressure control unit 107 to effectuate a recharging of the air brake control system 102. This is accomplished by bringing the pressure within the equalizing reservoir 105 back to its fully charged state as described above. With the equalizing reservoir 105 recharged, there is again a pressure differential (but opposite in sign to the previous pressure drop) between the ports 122 and 123 of the relay valve 117. This increase in pressure is sensed by the pneumatic valve module 204 in each railcar 200, and in response the brake shoes 233 are released by the action of the brake cylinders 231.

The railcar brake system 202 further includes a pneumatic power unit (PPU) 240 connected to the pneumatic valve module 204 for generating electricity from compressed air taken from the brake pipe 101. The PPU 240 is described in greater detail in the commonly owned patent application entitled, Methods and System for Generating Electrical Power from a Pressurized Fluid Source, filed on Sep. 14, 2000 and assigned application Ser. No. 09/661,660.

Each railcar 200 also includes a manual release rod 246 operative to release the brakes 233, as described further below, in conjunction with the pneumatic valve module 204. The manual release rod 246 can be placed in a momentary or a latched position by the train operator to effectuate different brake system responses.

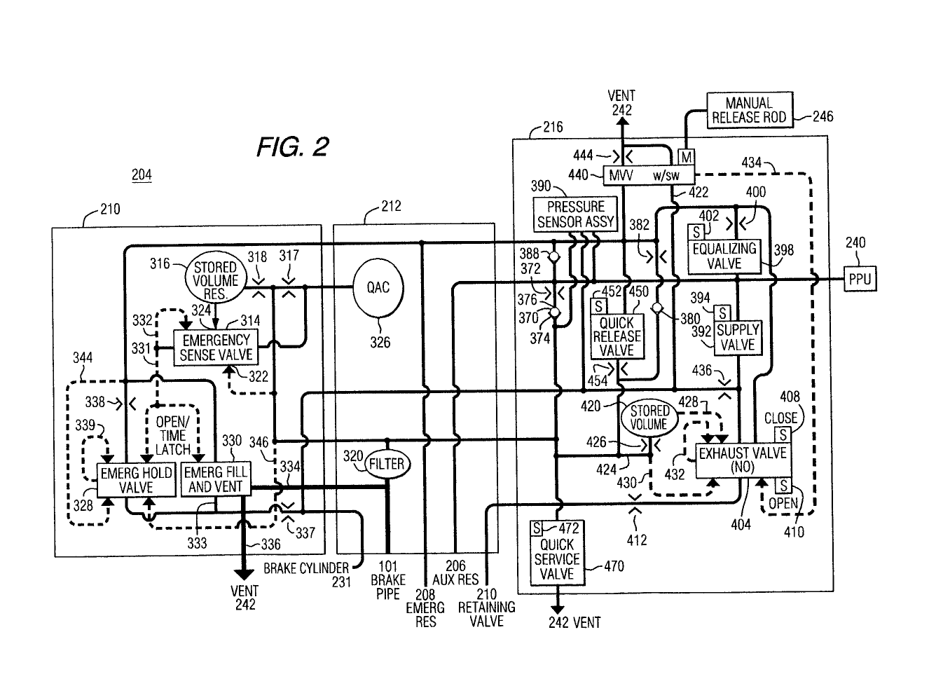

FIG. 2 is a pneumatic schematic diagram of the pneumatic valve module 204 constructed according to the teachings of the present invention and comprising an emergency portion 210, a brake pipe bracket 212 and a service portion 216. All the valves illustrated in FIG. 2 include a spring or other biasing device to urge the valve into its normal position when no other forces are present. The exhaust valve 404, to be discussed below, is a normally open valve; all other valves in the pneumatic valve module 204 are normally closed. Those skilled in the art recognize that the normal position of the valves can be reversed by appropriate modifications to the valve control mechanisms such that the same functionality is provided. Such modifications are considered to be within the scope of the present invention. In FIG. 2, solid lines represent major airflow paths and dashed lines represent pneumatic control paths. Control paths indicated as input to the bottom of the valve operate to close the valve path; control paths entering the valve from the top operate to open the valve. The exhaust valve, being a normally-open valve, is opened with a control air flow into the bottom and closed with control air flow into the top.

The present invention includes a plurality of chokes in the pneumatic valve module 204. A choke is a restricted orifice through which the airflow is limited by a reduction in the pipe diameter. The restriction thus lowers the air flow rate. Typically the input port of such chokes are responsive to a large volume of pressurized air and passing the air through the choke can provide a pneumatic timer mechanism. If the air pressure or volume is known (these two parameters are related by the ideal gas law and thus one value can be calculated if the other is known), the orifice diameter can be calculated so that the entire volume of air passes through the orifice in the desired time interval.

### Emergency Sense Valve 314

An emergency sense valve 314, according to the teachings of the present invention, is completely pneumatically actuated to provide emergency braking capability when the ECP system is operating in the conventional pneumatic control (CPC) mode (also referred to as the pneumatic emulation mode) or is inoperative. The emergency sense valve 314 responds to a brake pipe pressure reduction as follows. A stored volume reservoir 316 is responsive to the brake pipe 101 via a choke 318 and a filter 320 (for filtering debris from the brake pipe 101 to avoid contaminating and possible fouling of the PVM 204 valves) that is attached to the brake pipe bracket 212.

During an emergency brake application, the brake pipe pressure falls rapidly and the air flow through the choke 318 attempts to follow the pressure reduction. However the reduced choke orifice prohibits this response. In one embodiment, the choke 318 is designed to produce about a 2 psi differential when the pressure in the brake pipe drops at about 26 psi/sec from an initial pressure of 90 psi. It can be appreciated by those skilled in the art that these values are merely exemplary and do not state limitations of the present invention. The pressure at a control inlet 322 of the emergency sense valve 314 is connected directly to the brake pipe 101 and thus the pressure there drops immediately. Thus when the pressure supplied by the stored volume reservoir 316 at a control inlet 324 is about 2 psi greater than the pressure at the inlet 322, as determined by the brake pipe pressure, the emergency sense valve 314 opens.

When opened, the emergency sense valve 314 provides an air flow path from a quick action chamber 326, which is part of the brake pipe bracket 212, to open a normally-closed emergency hold valve 328 and a normally-closed emergency brake cylinder fill and brake pipe vent valve 330 over a link 331. The airflow from the quick action chamber 326 also latches the emergency sense valve in the open position over a link 332.

In one embodiment, the emergency brake cylinder fill and brake pipe vent valve 330 is held open for about 60-80 seconds in response to air supplied from the quick action chamber 326 via the emergency sense valve 314 over the link 331. A choke 317 is sized to create the 60-80 second open time interval of the link 331.

### Emergency Brake Cylinder Fill and Brake Pipe Vent Valve 330

The emergency brake cylinder fill and brake pipe vent valve 330 is connected to the emergency reservoir 208, to the brake cylinder 251 via a link 333, and to brake pipe 101 via a link 334. Thus, when opened, the emergency brake cylinder fill and brake pipe vent valve 330 provides an airflow path from the emergency reservoir 208 through link 333 and choke 337 to the brake cylinder 251. Choke 337 regulates the rate of flow to the brake cylinder, to control the rate of application of brake shoes 233 on the wheels 235, as it is not preferable to suddenly increase the brake cylinder pressure with air flow from the emergency reservoir 208. At the same time, the emergency brake cylinder fill and brake pipe vent valve 330 provides an airflow path from the brake pipe 101 to atmospheric vent 242 over a link 336 for the 60 to 80 second open time interval. This venting action increases the rate at which the brake pipe 101 is evacuated, commonly referred to as dumping the brake pipe. Since this evacuation occurs at each railcar 200, the rate at which the entire length of the brake pipe 101 is evacuated is much faster than the prior art ECP systems that dump the brake pipe 101 only at the locomotive. In one embodiment, the brake pipe 101 is evacuated at a rate that allows the initial application of emergency braking at each railcar over a two mile train consist to start to apply within about seven seconds.

### Emergency Hold Valve 328

Turning to the emergency hold valve 328, this valve supplies air from the emergency reservoir 208 through a choke 338, through the emergency hold valve 328, through choke 337 to the brake cylinder 231 to maintain the emergency brake cylinder pressure in the event of a leaky brake cylinder. The emergency hold valve 328 is latched open by the airflow from the emergency reservoir 208 over a latching link 339.

The emergency hold valve 328 is released (closed) under several different operating conditions. Closing the emergency hold valve cuts off the pressure maintaining feature for the emergency brake application (but does not release the brake application). The emergency hold valve 328 closes in response to a drop or release of the brake cylinder pressure as follows. Choke 338 is sized to block sudden pressure changes, such that a sudden drop in brake cylinder pressure will be seen on the control line 339, but will not be seen on the control line 344. In this instance, the pressure on the control line 344 (emergency reservoir pressure) is much greater than the released brake cylinder pressure (on the control line 339), causing the emergency hold valve 328 to close.

The emergency hold valve 328 is also closed in response to an increase in the brake pipe pressure via the link 346. This condition indicates the end of the emergency braking condition and a recharging of the brake pipe 101 to return to normal operation.

Thus as can be seen from the above discussion, the emergency sense valve 314, the emergency hold valve 328 and the emergency fill and vent valve 330 provide the capability to execute an emergency brake application without reliance on any ECP components or signals. This feature advantageously simplifies the design and operation of the braking system and provides a failsafe operational mode for the ECP system.

### Service Portion 216

The service brake portion 216 of PVM 204 is now described. An auxiliary reservoir check valve 370 has an opening or cracking pressure of about 0.5 psi in one embodiment. The airflow through the auxiliary reserve check valve 370 is limited by a serial choke 372. According to the schematic diagram of FIG. 2, airflow is permitted from an inlet port 374 to an outlet port 376 when the differential pressure between the ports exceeds the valve cracking pressure. The auxiliary reservoir check valve 370 is located between the auxiliary reservoir 206 and the brake pipe 231, and fills the auxiliary reservoir 206 from the brake pipe 101 whenever the cracking differential is exceeded.

An emergency reservoir check valve 380 also has an opening or cracking pressure of about 0.5 psi in one embodiment. The airflow through the emergency reservoir check valve 380 is limited by a serial choke 382. The emergency reservoir check valve 380 is located between the emergency reservoir 208 and the brake pipe 231, and fills emergency reservoir 208 from the brake pipe 101 when the cracking pressure differential is exceeded.

An emergency assist check valve 388, located between the auxiliary reservoir 206 and the emergency reservoir 208, also has a cracking pressure of about 0.5 psi. The emergency assist check valve 388 provides air from the auxiliary reservoir 206 to the emergency reservoir 208 to maintain the latter at full charge so that the brakes are applied as quickly as possible during an emergency condition.

Most of the valves within the service brake portion 216 are operated by a solenoid that drives a pilot valve to control the position of the main valve. The solenoids are actuated by a signal from a controller (not shown in FIG. 2) in response to various reservoir pressure values measured by a pressure sensor array 390, which comprises a plurality of pressure sensors for determining the pressure in the brake pipe 101, the brake cylinder 231 and the auxiliary reservoir 206. In another embodiment the pressure of the emergency reservoir 208 is also measured. Each of the pressure values is input to the controller for making decisions as to the application of signals to the various solenoids as described. Details of the controller operation are provided below in conjunction with the description of the various brake application and release modes and the valve operations required to implement those modes.

### Supply Valve 392

A supply valve 392 is operated by a solenoid 394, which drives a pilot valve to control the position of the supply valve 392. The supply valve 392 is thus responsive to signals from the controller (via the solenoid 394) to open and close, and control airflow air from the auxiliary reservoir 206 to the brake cylinder 231. Thus the supply valve is the mechanism through which service brake applications are made at the railcar 200. When operating in ECP mode, the control signal for the supply valve 392 is supplied by the train operator via the ECP communications system, in one embodiment an RF-based system, to the controller on each railcar 200.

When operative in the CPC mode, the pressure sensor array 390 detects a service application pressure drop in the brake pipe 101 and in response thereto inputs a signal representative thereof to the controller. In turn, the controller generates the signal to actuate the solenoid 394 and thereby open the supply valve 392 through which air is supplied from the auxiliary reservoir 206 to the brake cylinder 231.

### Equalizing Valve 398

An equalizing valve 398 is located between the auxiliary reservoir 206 and the emergency reservoir 208 for controlling the airflow between the auxiliary reservoir 206 and the emergency reservoir 208 via a choke 400 under control of a signal supplied to a solenoid 402. When an emergency brake application is commanded in the EPC mode, the equalizing valve 398 is activated by the controller, to allow airflow from the emergency reservoir 208 to the auxiliary reservoir 206 to assist in making electronic emergency applications. The equalizing valve 398 is also used to supply air flow from the emergency reservoir 208 to the auxiliary reservoir 206 to equalize the reservoir pressures in conjunction with certain CPC mode functions. In this mode the choke 400 provides for a graceful equalization process between the two reservoirs so that unintended brake applications and releases are not initiated, due to pressure changes in the auxiliary reservoir 206.

The pneumatic power unit 240 is also connected to the auxiliary reservoir 206 as shown.

### Latching Exhaust Valve 404

A latching exhaust valve 404 is a normally open valve comprising a closing solenoid 408 for closing the exhaust valve 404 and opening solenoid 410 for opening the exhaust valve 404. When closed, the exhaust valve prevents air in the brake cylinder 231 from venting to the atmosphere. To release the brakes, the exhaust valve 404 is opened by an appropriate signal from the controller applied to the opening solenoid 410 and thus the brake cylinder 231 is vented to atmosphere via a choke 412 and the retaining valve 210. As discussed above, the retaining valve 210 can be manually set to retain a certain brake cylinder pressure notwithstanding the venting to atmosphere.

Once closed, the exhaust valve 404 is held closed by emergency reservoir air supplied over a latching link 432. According to the prior art, the exhaust valve is controlled by a single solenoid for closing the valve. Therefore during a brake application the prior art solenoid must be continuously energized to hold the exhaust valve closed. Since the brake application duration can be lengthy, for example, if the train is parked at a siding, the prior art exhaust valve consumes considerable power at each railcar 200.

To open the exhaust valve 404, a signal is sent from the controller to the opening solenoid 410, the opening solenoid force exceeds the latching force supplied over the link 414 and the exhaust valve 404 opens. The exhaust valve is held open by an internal spring that holds the valve in the normally open position.

If the electronic controller or the opening solenoid 410 are not operational, the exhaust valve 404 can still be opened pneumatically by a sudden increase in brake pipe pressure commanding a brake release. A sudden increase in brake pipe pressure causes a corresponding pressure increase in a link 430. A choke 426 prevents a link 428 from seeing the pressure rise. Thus the sudden pressure rise in link 430 causes the exhaust valve 404 to shift to the open position. Note that the sudden increase in brake pipe pressure can come from the brake pipe 101 as a result of a brake release signal issued by the locomotive operator in CPC mode. Actuation of a quick release valve 450, as described below, can also cause this sudden increase in brake pipe pressure. Thus a redundant control path is created for opening the exhaust valve 404 and releasing brakes.

Since the exhaust valve is normally open and thus provides an open air path from the brake cylinder 231 to the retaining valve 414, when an emergency brake application is to be executed by the emergency portion 292, the exhaust valve 404 must first be closed to prevent the brake cylinder air from being vented through the retaining valve 414 to the atmosphere. This is accomplished by an appropriate controller-generated signal to the closing solenoid 408 that closes the exhaust valve 404. However, if the controller is not operational, the exhaust valve 404 must be closed through an alternative pneumatic process. This alternative process proceeds as follows. A stored volume reservoir 420 is connected the brake pipe 101 via the choke 426 and the link 424, and is further connected to the link 428. The link 430 is also connected to the link 424. When the brake pipe pressure drops faster than a predetermined threshold, the choke 426 prevents the pressure of the stored volume reservoir 420 from dropping at the same rate as the brake pipe pressure. The pressure on the link 430 thus drops faster than the pressure on the link 428, causing sufficient pressure differential to close the exhaust valve 404. Once the exhaust valve 404 closes, emergency reservoir pressure is provided to the link 432 to latch the valve closed. The exhaust valve remains closed until the opening solenoid 410 is activated or until a manual vent action is initiated, providing an opening pneumatic control signal over a link 434.

Additional details of the latching exhaust valve are disclosed and claimed in the commonly-owned patent application entitled Latching Exhaust Valve filed on Sep. 14, 2000 and bearing application Ser. No. 09/661,354, and the commonly-owned patent application entitled Latching Exhaust Valve Control, filed on______and bearing application No. ______.

### Manual Vent Valve 440

A manual vent valve 440 is manually activated by train personnel by applying force to the manual release rod 246 on each railcar 200. Typically, the force required is about 15 to 25 pounds force. The manual vent valve 440 closes when the manual actuation force is removed. When the manual release rod 246 is momentarily activated, the manual vent valve 440 momentarily opens and allows airflow from the emergency reservoir 208 over link 434 to cause the exhaust valve 404 to open, releasing the air in the brake cylinder 231 through the a choke 436, through the exhaust valve 404 and to atmosphere via the retaining valve 210.

There is also a second path to vent the brake cylinder 231 via a link 422, through the manual vent valve 440, to the vent 242. This second path is opened when the manual vent valve 440 is open. This second path is advantageous in the event that the retaining valve is set (i.e., closed). There are some conditions, as described above, under which the retaining valve 210 is set to retain about 20 psi of air in the brake cylinder 232. Thus, venting the brake cylinder 231 through the retaining valve 210 will not result in a complete brake cylinder evacuation. The second path provides a direct path to atmosphere to ensure the railcar brakes are completely released.

If the manual release rod 246 is held in the activation position, the manual vent valve 440 releases the air in the emergency reservoir 208 to the vent 242 via a choke 444 and also releases brake cylinder pressure via the link 422 to the vent 242. The auxiliary reservoir 206 will also be vented when the emergency reservoir 208 is vented by opening of the emergency assist check valve 388. This venting also occurs through the manual vent valve 440.

### Quick Release Valve 450

A quick release valve 450 is controlled by a solenoid 452, which is in turn controlled by the controller, to provide a path for air in the emergency reservoir 408 to refill the brake pipe 101, thus reducing the brake pipe refill time. This airflow is regulated by a choke 454.

Recall that brake applications using the brake pipe pneumatic signalling system cannot be made if the brake pipe 101 is not in a charged state. Thus a faster refilling of the brake pipe 101 with emergency air from each railcar 200 reduces the time during which these brake applications cannot be made. When a rise in brake pipe pressure is detected by the pressure sensor array 390 an appropriate signal is sent by the controller to the solenoid 452 to open the quick release valve 450 for a predetermined time period. This action opens a path from the emergency reservoir 208 to the brake pipe 101.

The quick release valve 450 can also be used to insert pneumatic ping patterns or pressure variations on the brake pipe 101 for communicating information between the railcars 200 and locomotive 100 of a train consist, as taught by the commonly-owned patent application entitled, Pneumatic-Based Communications System, filed on Mar. 25, 2002 and assigned application Ser. No. 10/105,645.

### Quick Service Valve 470

A quick service valve 470, including an integral choke, is controlled by a solenoid 472 to allow graceful venting of brake pipe air to the to atmosphere via vent 242. In the CPC operational mode, when the pressure sensor array 390 senses a brake pipe reduction calling for a service brake application, the controller actuates the solenoid 472 to open the quick service valve 470 to more quickly vent the brake pipe 101 and propagate the brake application command down the train. The quick service valve 470 also provides accelerated application functions in CPC mode of operation. Quick service and accelerated applications allow for faster propagation of brake pipe reduction signals down the train.

### Operational Modes

The various operational modes of the PVM 204 are described below, including both ECP and CPC modes. In ECP mode, the PVM 204 is controlled by a radio (or wired) communications signal. In CPC mode (also referred to as the emulation mode), the PVM is controlled by brake pipe signals in the form of brake pipe pressure increases and decreases initiated at the locomotive by the operator.

Service brake applications in the EPC mode are executed when the controller on the railcar 200 receives an electronic service brake command from the locomotive operator. In response, the controller energizes the closing solenoid 408 associated with the exhaust valve 404 for a period of about 100 milliseconds (in one embodiment). The action of the closing solenoid 408 causes the exhaust valve 404 to latch closed due to the emergency reservoir air supplied to the exhaust valve 404 over the link 432. When closed, the exhaust valve 404 closes the path from the break cylinder 231 to the retaining valve 210 and from there to the atmosphere.

Also, in response to the ECP signal, the controller energizes the solenoid 394 associated with the supply value 392, opening the supply value 392 to establish a path from the auxiliary reservoir 206 to the brake cylinder 231 for a period of time representing the amount of braking commanded. For example, a full service brake application would cause the supply valve to open for a total of about six seconds. Thus the auxiliary reservoir air flows into the brake cylinder 231 to obtain the desired braking pressure.

An emergency brake application in the ECP mode proceeds as follows. The controller on each railcar receives an emergency brake command via the communications network, and in response energizes the closing solenoid 408 of the exhaust value 404. As in the case of a service brake application, the exhaust valve 404 latches closed via emergency reservoir air over the link 414, thereby closing off the path between the brake cylinder 231 and the retaining valve 210.

In further response to the ECP mode emergency brake command, the controller also energizes the solenoid 394 of the supply valve 392 and cycles solenoid 402 of the equalizing valve 398 for about eight seconds. As a result, auxiliary reservoir air flows into the brake cylinder 231 via the supply value 390. Also, emergency reservoir air flows into the auxiliary reservoir 206 via the equalizing valve 398 to provide the auxiliary reservoir 206 with the necessary volume of air for the emergency brake application.

When the EPC system is inoperative or the conventional/emulated mode is selected, a service brake application begins when the controller detects a sufficient reduction in the brake pipe pressure via the pressure sensor array 390. In response, the controller energizes the closing solenoid 408 to close the exhaust valve 404. The exhaust valve 404 latches closed with auxiliary reservoir air over the link 414, thereby closing off the path from the brake cylinder 231 to the retaining valve 210. The controller also sends a series of pulses to the solenoid 472 of the quick service valve 470. This emulates the quick service and accelerated application functions performed by conventional brake system valves. For the duration of each pulse, the quick service valve 470 vents a small amount of brake pipe 101 air, and thus helps propagate the brake pipe pressure reduction toward the rear of the train. The controller also energizes the solenoid 392 of the supply valve 390 to open the supply valve for the desired period of time, which is determined by the magnitude of the brake pipe reduction initiated by the locomotive for the commanded service brake application. When the supply valve 390 is opened, auxiliary reservoir air is supplied to the brake cylinder 231.

The ECP system is designed so that when a pneumatic emergency brake pipe evacuation is detected, there will be a pneumatic response whether the ECP system is operating in the ECP mode or in CPC mode, or even if the system electronics are inoperative. The pneumatic response, which is executed by the emergency portion 210 of the PVM 204, begins as the brake pipe pressure drops at an emergency rate. The pressure drop initiates a race condition between the brake pipe pressure and the stored volume pressure within the stored volume reservoir 316. When the pressure in the stored volume reservoir 316 is about 2 to 3 psi above the brake pipe pressure, the emergency sense valve 314 opens and latches open using air supply form the quick action chamber 326. In turn, this allows air to flow from the emergency reservoir 208 to actuate the emergency hold valve 328 and the emergency brake cylinder fill and brake pipe vent valve 330.

The emergency brake cylinder fill and brake pipe vent valve 330 vents the brake pipe 101 to the vent 242, thus accelerating the propagation of the emergency brake signal toward the rear of the train. The emergency brake cylinder fill and brake pipe vent valve also provides for emergency brake cylinder pressure via the link 333 to the brake cylinder 231.

If the exhaust valve 404 is not closed electrically as described above, then it will close pneumatically due to the decreased pressure in the brake pipe caused by the pneumatic emergency. This process occurs as the stored volume reservoir 420 supplies air to the exhaust valve 404 over the link 428. In one embodiment, there must be about a 3 psi difference between the pressure supplied over the link 428 and the pressure supplied over the link 430 to close the exhaust valve 404. The pressure on the link 430 closely follows the falling brake pipe pressure, but the pressure on the link 428 is held slightly higher by action of the choke 426. When this pressure differential reaches about 3 psi, the exhaust valve closes. The exhaust valve 404 latches in the closed position using air from the emergency reservoir 208.

When opened, the emergency hold valve 328 maintains emergency reservoir air to the brake cylinder 231. After about sixty to ninety seconds, the quick action chamber 326 will have emptied, which in turn closes the emergency brake cylinder fill and brake pipe vent valve 330. The emergency hold valve 328 is latched in the open position by the brake cylinder pressure supplied over the link 339. Thus the emergency hold valve 328 continues to supply emergency air from the emergency reservoir 208 to the brake cylinder 231 after the emergency brake cylinder fill and brake pipe vent valve 330 has closed.

When in the ECP mode, a service or an electronic emergency (i.e., initiated without venting of the brake pipe) brake application is released as follows. When the controller receives the brake release command over the communications network, it energizes the opening solenoid 410 associated with the exhaust valve 404. The exhaust valve 404 opens and the brake cylinder is vented through the exhaust valve 404 to the retaining valve 210 to the atmosphere.

When in CPC mode, a service brake application is released in a similar manner. When the controller detects a brake release command (brake pipe pressure rise), controller actuates the opening solenoid 410 to open the exhaust valve 404. Brake cylinder air is then vented into the exhaust valve 404 through the retaining valve 210 to the atmosphere. The controller also actuates the solenoid 452 to open the quick release valve 450, which recharges the brake pipe 101 from the emergency reservoir 208. Thus the airflow from the emergency reservoir 208 into the brake pipe 101 propagates the brake release signal down the train.

A pneumatic emergency brake application can be released from either the EPC or the CPC mode. The brake pipe pressure begins to rise and when it reaches about 30 to 35 psi the emergency hold valve 328 closes in response to the air supplied over the link 346. The pressure sensor assembly 390 detects the brake pipe pressure increase and in response the controller actuates the solenoid 452 to open the quick release valve 450 so that emergency reservoir air flows into the brake pipe 101, thus accelerating the propagation of the brake release command by increasing the brake pipe pressure toward the back of the train. The controller will keep the exhaust valve 404 closed by energizing the closing solenoid 408 while the quick release valve is open to prevent releasing of the brakes until the desired time. The brake pipe pressure continues to rise until it is approximately equal to the auxiliary reservoir pressure. This condition is detected by the pressure sensor array 390 and the controller opens the exhaust valve 404 (by energizing the opening solenoid 410) to release the brakes by evacuating the brake cylinder through the retaining valve 210 to the atmosphere.

As discussed briefly above, certain manual actions can also be used to release service and emergency brake applications and also vent the various reservoirs associated with the pneumatic valve module 204. When an operator pulls the railcar's manual release rod 246 the manual vent valve 440 opens and actuates a position sensing switch within the manual vent valve 440. The position sensing switch signals to the controller that manual vent valve has been manually actuated, so that the controller does not attempt to override the manual release of brake cylinder pressure. Opening the manual vent valve 440 pressurizes link 434, which opens the exhaust valve 404. When the exhaust valve is opened the brake cylinder vents through the exhaust valve 404 to the retaining valve 210 and then to the atmosphere.

When it is desired to deplete the various reservoirs, the operator pulls and holds the manual release rod 246 for about fifty to eighty seconds depending on the current reservoir air pressures. A shorter hold time is required when the reservoirs are partially depleted. This action opens the manual vent valve 440 allows emergency reservoir and auxiliary reservoir (via check valve 388) air to vent to atmosphere through vent 242. Brake cylinder air also has a direct path to atmosphere via the link 422 and the vent 242. The exhaust valve 404 opens when emergency reservoir air pressure is supplied over the link 434, which then allows the venting of air from the brake cylinder 231 through the retaining valve 210.

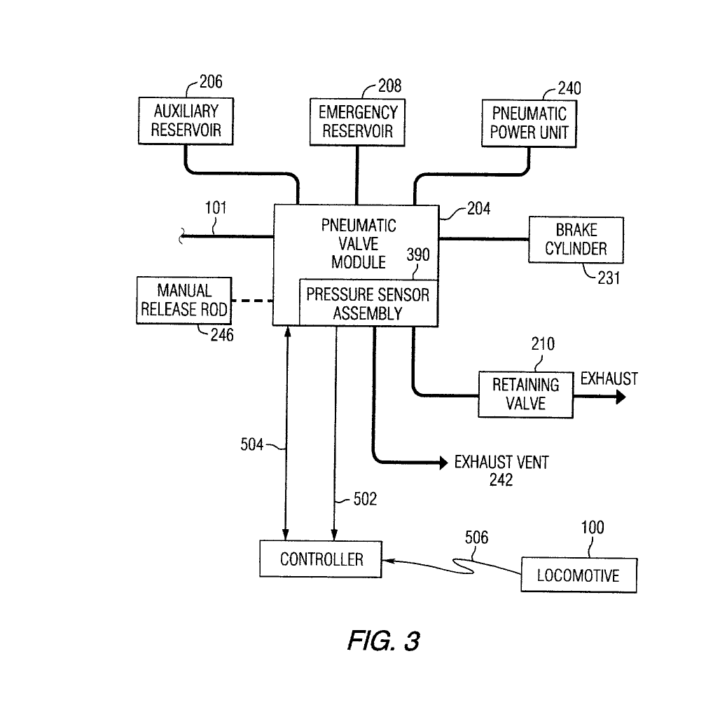

FIG. 3 is illustrates the PVM 204 in block diagram form, together with the principle components with which it operates as described above. Double lines in FIG. 3 represent air flow paths; single lines represent electrical signal paths; dashed lines represent mechanical actuation or mechanical coupling. FIG. 3 also illustrates a controller 500 responsive to pressure-representative signals from the pressure sensor array 390 over a conductor 502 and for providing control signals to the various solenoids of the PVM 204 as discussed above, over a conductor 504. Various EPC signals, as discussed above, are supplied to the controller 500 from the locomotive 100 over a communications link 506, which can be RF or wire based.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for providing brake control of a railcar comprising a brake cylinder, a brake pipe, a reservoir, a brake valve and an electronic controller, said method comprising:
creating a pneumatic emergency signal in the brake pipe;
at the brake valve, sensing the pneumatic emergency signal; and
supplying a first air flow from the reservoir to the brake cylinder in response to the pneumatic emergency signal without intervention of the electronic controller.

2. The method of claim 1 wherein the electronic controller is responsive to the brake cylinder pressure, the brake pipe pressure and the reservoir pressure for controlling air flow into the brake cylinder.

3. The method of claim 1 further comprising venting the brake pipe to decrease the propagation time of the pneumatic emergency signal along the brake pipe.

4. The method of claim 1 further comprising supplying a second air flow to the brake cylinder at a lower rate than the first air flow.

5. The method of claim 1 wherein the brake valve comprises an emergency sense valve for sensing the pneumatic emergency signal.

6. The method of claim 5 wherein the step of supplying the first air flow further comprises creating a pressure differential between a first control inlet and a second control inlet of the emergency sense valve to open the emergency sense valve when the pressure differential exceeds a predetermined value such that in response thereto air flow is supplied from the reservoir to the brake cylinder.

7. The method of claim 6 wherein the pneumatic emergency signal in the brake pipe comprises a pressure drop, and wherein the pressure differential is created in response to a predetermined pressure drop rate.

8. The method of claim 6 further comprising latching the emergency sense valve in the open position for a predetermined period of time.

9. The method of claim 5 wherein the brake valve comprises an emergency fill and vent valve, and wherein the method further comprises:
opening the emergency fill and vent valve through the application of control air flow through the open emergency sense valve;
venting the brake pipe through the open emergency fill and vent valve;
providing reservoir air flow to the brake cylinder through the open emergency vent and fill valve.

10. The method of claim 5 wherein the brake valve comprises an emergency hold valve, and wherein the method further comprises:
opening the emergency hold valve through the application of control air flow through the open emergency sense valve;
supplying a second air flow to the brake cylinder at a lower rate than the first air flow through the open emergency hold valve.

11. The method of claim 1 wherein the brake valve comprises a check valve, and wherein the method further comprises filling the reservoir from the brake pipe through the check valve when the cracking pressure differential of the check valve is exceeded.

12. The method of claim 1 further comprising maintaining the charge of the reservoir by supplying air thereto while the reservoir is supplying the first air flow to the brake cylinder.

13. A method for providing brake control of a railcar comprising a brake cylinder, a brake pipe, a reservoir, a brake valve and an electronic controller, in response to pneumatic brake control signals sent via the brake pipe and electrical brake control signals sent via a communications medium, wherein operational conditions determine whether one or both of the pneumatic brake control signal and the electrical brake control signal are present, said method comprising:
when the pneumatic brake control signal is present, sensing the pneumatic brake control signal at the brake valve;
controlling the brake cylinder pressure in response to the sensed pneumatic brake control signal;
when the electrical brake control signal is present, detecting the electrical brake control signal at the electronic controller; and
controlling the brake cylinder pressure in response to the electrical brake control signal.

14. The method of claim 13 wherein the pneumatic brake control signal and the electrical brake control signal command brake control actions selected from among a service brake application, an emergency brake application and a brake release.

15. The method of claim 13 wherein the communications medium is selected from among an electrical conductor and an electromagnetic radiation carrying medium.

16. The method of claim 13 wherein a first operational condition comprises an electronically controlled pneumatic mode such that the electrical brake control signals control the railcar brakes, and wherein a second operational condition comprises a conventional pneumatic control mode such that the pneumatic brake control signals control the railcar brakes.

17. The method of claim 16 wherein an emergency brake control signal on the brake pipe is sensed by the brake valve whether the first or the second operational condition exists, and wherein in response thereto the brake cylinder pressure is controlled to make an emergency brake application.

18. The method of claim 13 further comprising supplying air flow directly from the reservoir to a pneumatic power unit for generating electrical power.

19. A method for providing brake control of a railcar comprising a brake, a brake pipe, an auxiliary reservoir, an emergency reservoir, a brake valve further comprising a normally-open latching exhaust valve, and an electronic controller, said method comprising:
closing the exhaust valve during a brake application;
opening the exhaust valve during a brake release;
latching the exhaust valve closed during a brake application by supplying emergency reservoir air thereto.

20. The method of claim 19 wherein the step of closing the exhaust valve further comprises providing a control signal from the electronic controller to the exhaust valve.

21. The method of claim 19 wherein the step of closing the exhaust valve further comprises:
in response to the brake pipe pressure drop, supplying air at a first pressure via a first orifice for closing the exhaust valve;
in response to the brake pipe pressure drop, supplying air at a second pressure via a second orifice for opening the exhaust valve;
wherein the diameter of the first orifice is less than the diameter of the second orifice, such that there is a delay between the brake pipe pressure drop and a representative drop in the first pressure, and such that the second pressure follows the brake pipe pressure;
closing the exhaust valve when the first pressure exceeds the second pressure; and
latching the exhaust valve in the closed position.

22. The method of claim 21 wherein the air is supplied at the first pressure by the serial connection of a choke and a stored volume reservoir, and wherein an input port of the choke is connected to the brake pipe and an output port thereof is connected to the stored volume reservoir, wherein the output port of the stored volume reservoir supplies the air at the first pressure.

23. The method of claim 19 further comprising manually opening the exhaust valve to release the brakes.

24. A method for providing brake control of a railcar comprising a brake cylinder, a brake pipe, a reservoir, a brake valve, a manual release actuator and an electronic controller, said method comprising:
actuating the manual release actuator to initiate a brake release;
supplying air pressure from the reservoir to the exhaust valve in response to the actuating step;
opening the exhaust valve in response to supplying air pressure step; and
venting the air pressure in the brake cylinder through the open exhaust valve.

25. The method of claim 24 further comprising:
actuating a switch in response to the actuating step;
sensing the switch position by the electronic controller; and
refraining from brake applications by the electronic controller in response to the switch position.

26. A brake valve for providing brake control of a railcar in response to pneumatic brake control signals carried over a brake pipe and electrical brake control signals carried over a communications medium, wherein said brake valve selectably operates in a pneumatic mode for receiving the pneumatic brake control signals or in an electrical mode for receiving the electrical brake control signals, wherein brake control is effected by supplying air to a brake cylinder from an air reservoir or by releasing air from the brake cylinder, said brake valve comprising:
an emergency sense valve responsive to the brake pipe for detecting a pneumatic emergency brake signal, whether the brake valve is operative in the pneumatic mode or the electrical mode;
an emergency fill and vent valve responsive to the position of the emergency sense valve and connected to the brake pipe and the brake cylinder for supplying air from the reservoir to the brake cylinder when in the open position and further for venting the brake pipe when in the open position.

27. The brake valve of claim 26 wherein the pneumatic emergency brake signal opens the emergency sense valve, which in turn opens the emergency fill and vent valve.

28. The brake valve of claim 26 further comprising an emergency hold valve responsive to the position of the emergency sense valve, wherein when said emergency hold valve is opened air is supplied at a relatively low pressure from the reservoir to the brake cylinder.

29. The brake valve of claim 28 wherein the emergency hold valve is opened in response to an opened emergency sense valve.

30. The brake valve of claim 29 further comprising a stored volume reservoir having an input port responsive to the brake pipe via a choke, and an output port connected to an opening port of the emergency sense valve, and a closing port connected responsive to the brake pipe, wherein when the brake pipe pressure is reduced at a predetermined rate, the air pressure at the opening port is greater than the air pressure at the closing port, such that the emergency sense valve opens.

31. The brake valve of claim 30 further comprising a quick action chamber wherein when the emergency sense valve is opened air is supplied from said quick action reservoir through the opened emergency sense valve to the open the emergency fill and vent valve and the emergency hold valve.

32. A brake valve for providing brake control of a railcar in response to pneumatic brake control signals carried over a brake pipe and electrical brake control signals carried over a communications medium, wherein said brake valve selectably operates in a pneumatic mode for receiving the pneumatic brake control signals or in an electrical mode for receiving the electrical brake control signals, wherein brake control is effected by supplying air to a brake cylinder from an air reservoir or releasing air from the brake cylinder, said brake valve comprising:
a supply valve responsive to the brake pipe for effecting brake control in response to the brake pipe pressure;
an electronic controller; and
a pressure sensor responsive to the brake pipe for providing a signal representative thereof to said electronic controller, wherein in response thereto said electronic controller controls said supply valve for effecting brake control.

33. The brake valve of claim 32 wherein the pressure sensor is further responsive the reservoir pressure.

34. The brake valve of claim 32 wherein the pressure sensor is further responsive to the brake cylinder pressure.

35. The brake valve of claim 32 wherein the communications medium is selected from among a conductive wire and a wireless link over which electromagnetic energy is propagated.

36. A brake valve for providing brake control of a railcar in response to pneumatic brake control signals carried over a brake pipe and electrical brake control signals carried over a communications medium, wherein said brake valve selectably operates in a pneumatic mode for receiving the pneumatic brake control signals or in an electrical mode for receiving the electrical brake control signals, wherein brake control is effected by supplying air to a brake cylinder from an air reservoir or by releasing air from the brake cylinder, said brake valve comprising:
an exhaust valve for releasing the brakes by evacuating the brake cylinder, wherein the exhaust valve is closed during a brake application;
an electronic controller responsive to electrical brake control signals for closing the exhaust valve during a brake application.

37. The brake valve of claim 36 further comprising:
a stored volume reservoir having an input port connected to the brake pipe via a choke and having an output port connected to a closing port of the exhaust valve;
wherein the exhaust valve further comprises an opening port connected to the brake pipe;
wherein pressure reductions in the brake pipe are sensed at the closing port after a time delay from sensing at the opening port; wherein the greater pressure at the closing port closes the exhaust valve.

38. The brake valve of claim 37 wherein the exhaust valve comprises a latching link for holding the exhaust valve in the closed position, and wherein reservoir air is supplied to said latching link.
